(19) United States
(12) Patent Application Publication
(10) Pub. No.: US 2012/0084122 A1
(43) Pub. Date: Apr. 5, 2012

(54) COUPON INTEGRATION WITH SHOPPING LISTS

(76) Inventor: Jason Boehle, Lawrence, KS (US)

(21) Appl. No.: 12/896,206

(22) Filed: Oct. 1, 2010

(51) Int. Cl. G06Q 30/00

(52) U.S. Cl. 705/14.1

(57) ABSTRACT

In an embodiment, an application receives data indicating that a user has selected a coupon offer. The application identifies an item that is associated with the selected coupon offer. In response, the application adds the item to a shopping list for the user. In an embodiment, an application receives data indicating an item that has been added to a shopping list. The application identifies one or more coupon offers based on data associated with the item. In response, the application presents the one or more coupon offers to the user. Responsive to presenting the one or more coupon offers to the user, the application receives selection, from the user, of a particular coupon offer of the one or more coupon offers. In response to the user selecting the particular coupon offer, the application generates a print or electronic coupon for the particular coupon offer.

### TECHNICAL FIELD

Embodiments relate generally to coupon distribution, and, more specifically, to techniques for integrating coupon distribution with shopping list management.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

In general, a coupon is a certificate that entitles its holder to accept an offer described or referenced by the coupon. The offer, also subsequently referred to as the “coupon offer,” may be any type of offer, but is in general an offer by the coupon provider to provide a customer with one or more goods or services at a typically discounted price, or to provide the customer with a gift in exchange for the performance of an act, such as purchasing a good or service.

A coupon often takes a “hard copy” form, such as a paper certificate, printed on which are images and/or text describing terms of the offer. “Coupon codes”—alphanumeric or other codes that are associated with an offer—are another example form in which coupons may be generated. Electronic forms, such as digital images and digital certificates, may also be generated. Electronic forms may be stored on a physical device belonging to a user, such as a computer hard drive or a mobile communication or storage device. Electronic forms may also be stored on devices that do not belong to the user—for example, in a database belonging to a coupon distributor or a retailer. In such cases, a user may redeem the electronic coupon by presenting credentials during the checkout process, such as a smart card, identification card, and/or personal information. The credentials allow the retailer to locate the coupon in an appropriate database.

The process of the user accepting a coupon offer by purchasing, contracting, or otherwise transacting with another party shall hereinafter be referred to as “redeeming” the coupon. For example, a customer may redeem a hard copy of a coupon by handing the copy to a clerk during a purchase at a retail store. As another example, a customer may redeem an electronic coupon during an online or “brick-and-mortar” checkout process by supplying a coupon code or a customer loyalty card identifying an account with which an electronic coupon has been associated. As another example, the customer may display or transmit a secure digital copy of the coupon from a mobile or storage device. Coupon redemption may or may not require the redeeming party to yield their coupon. The techniques described herein are applicable to coupons in any redeemable form.

While coupons have conventionally been distributed to customers by hand, such as via mail or newspapers, recent distribution techniques now provide customers with opportunities to print or otherwise generate their own coupons. For example, a number of websites provide search engines with which users may search for offers and then print coupons for the offers they find. Some of these websites may employ mechanisms to control the number of times that a given offer may be printed by a customer, by a device, and/or in aggregate. The printed coupons may be used in the same manner as any other coupon. An entity that distributes a coupon by this or any other mechanism is herein referred to as a coupon distributor. A coupon distributor may also be a coupon provider, such as a manufacturer or retailer of a coupon-eligible product, or the coupon distributor may be an entity that distributes coupons on behalf of one or more coupon providers.

The process of distributing a coupon is often described herein with reference to the distribution of tangible, printed coupons. However, the techniques described herein may also be utilized to distribute coupons in any redeemable form that may be generated by a computing device. Thus, any step of printing a coupon described herein may be substituted with a step of generating a redeemable coupon in any form, including an electronic copy.

Customers often do not take advantage of coupon offers to which they may be entitled because they are unaware of or do not have convenient access to coupon offers. In turn, from a retailer or advertiser perspective, the value of a coupon campaign may therefore be diminished

### BRIEF DESCRIPTION OF THE DRAWINGS

In the drawings:

FIG. 1 illustrates an example system in which the techniques described herein may be practiced;

FIG. 2 depicts an example interface for viewing and manipulating shopping lists;

FIG. 3 depicts an example interface for viewing and selecting coupon offers;

FIG. 4 is a flow chart illustrating an example method for updating a shopping list in response to the selection of a coupon offer;

FIG. 5 is a flow chart illustrating an example method of assisting a user in locating coupon offers based on items that have been added to a shopping list;

FIG. 6 is a flow chart illustrating an example method of location-aware coupon notification;

FIG. 7 is a flow chart illustrating a method of aisle-based coupon presentation; and

FIG. 8 is block diagram of a computer system upon which embodiments of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

Embodiments are described herein according to the following outline:
1.0. General Overview
2.0. Structural Overview
3.0. Functional Overview
   3.1. Shopping List Management
   3.2. Coupon Distribution
   3.3. Adding Shopping List Items upon Coupon Selection
   3.4. Presenting Coupon Offers upon Adding Shopping List Items
   3.5. Location-Aware Coupon Notification
   3.6. Aisle-Based Coupon Presentation
   3.7. Coupon Eligibility Validation
   3.8. Sharing Data
4.0. Implementation Mechanism—Hardware Overview
5.0. Extensions and Alternatives

### 1.0. General Overview

Approaches, techniques, and mechanisms are disclosed for integrating coupon distribution with shopping list management. According to an embodiment, an application receives data indicating that a user has selected a coupon offer. The application identifies an item that is associated with the selected coupon offer. In response to receiving the data indicating the selection of the coupon offer by the user, the application adds the item to a shopping list for the user.

In an embodiment, data indicating the selection of the coupon offer by the user further indicates that the user selected to receive a print or electronic coupon for the coupon offer. In an embodiment, the shopping list includes one or more other items not associated with the selected coupon offer. In an embodiment, the application displays in the shopping list, with the item, an indication that the user selected the coupon offer. In an embodiment, adding the item to a shopping list for the user is performed further in response to the user selecting the item from a list of one or more items eligible for the selected coupon offer.

In an embodiment, the application identifies a plurality of items required for eligibility for the selected coupon offer. The application determines that at least one or the plurality of items is not in the user's shopping list. In response to the determining, the application performs at least one of: notifying the user that the at least one item is not in the user's shopping list; or automatically adding the at least one item to the user's shopping list.

According to an embodiment, an application receives data indicating an item that has been added to a shopping list. The application identifies one or more coupon offers based on data associated with the item. In response to receiving the data indicating the item that has been added to the shopping list, the application presents the one or more coupon offers to the user. Responsive to presenting the one or more coupon offers to the user, the application receives selection, from the user, of a particular coupon offer of the one or more coupon offers. In response to the user selecting the particular coupon offer, the application generates a print or electronic coupon for the particular coupon offer.

In an embodiment, the application displays in the shopping list, with the item, an indicator that the user selected the particular coupon offer. In an embodiment, identifying the one or more coupon offers based on the data associated with the item comprises one or more of: identifying at least one coupon offer that may be applied to the purchase of the item; identifying one or more other items associated with the item and identifying at least one coupon offer that may be applied to the purchase of the one or more other items; ensuring that the one or more coupon offers does not include any coupon offers that may be applied to the purchase of the item; and/or identifying a plurality of coupon offers that may be applied to the purchase of the item and selecting, from the plurality of coupon offers, only those coupon offers that require the purchase of one or more items in addition to the item.

In an embodiment, the application identifies one or more other items that must be purchased with the item for the item to be eligible for the particular coupon offer. The application then adds the one or more other items to the shopping list. In an embodiment, the data indicating the item that has been added to the shopping list further indicates that the user has marked the item as being in the user's shopping cart.

According to an embodiment, coupon distribution technology is embedded within a shopping list application. Items may be added to the shopping list based on selected coupon offers. Also, coupon offers may be presented to and selected by the user based on items that have been added to the shopping list. The shopping list application may provide location-aware displays of coupon data and/or shopping lists. The shopping list application may further provide aisle-based displays of coupon data and/or shopping lists. The shopping lists and/or coupon data may be shared between users, for instance, via mobile applications, thus allowing collaborative shopping efforts. The shopping list application may further include validation mechanisms to ensure that items in shopping lists and/or shopping carts meet coupon eligibility requirements.

According to an embodiment, a coupon distributor provides a user with a software application for locating and accessing coupon offers. When a user has located a coupon offer of interest to the user, the user may utilize the application to select the coupon offer. Upon selection of the coupon offer, the application may generate a coupon for the coupon offer, or save the coupon offer for later reference. The application further identifies one or more items associated with the coupon offer. The application then adds these one or more items to a shopping list for the user. As the user selects additional coupon offers, additional items are added to the shopping list. The user may subsequently print this shopping list via the application, or, in the case of a mobile application, may access the shopping list directly via the application while shopping.

According to an embodiment, a user creates a shopping list with a software application. In response to adding an item to the shopping list, the application searches coupon data for coupon offers associated with the item and/or for coupon offers associated with data related to the item, such as one or more categories of products to which the item pertains. The application presents some or all the coupon offers it finds to the user via any of a variety of mechanisms, including pop-up alerts, indicators next to the item (or a category associated with the item), and/or a separate listing of coupon offers that may be of interest to the user. The user may select coupon offer(s) of actual interest to the user via this presentation.

According to an embodiment, a user installs a coupon application on a mobile device, such as a phone, tablet, personal digital assistant, or other personal computing device. The coupon application maintains a list of coupon offers that have been selected by a user. The coupon application interfaces with location detection logic and/or hardware on the mobile device to identify a location associated with the user. When the location is within a threshold distance from a place at which a selected coupon offer may be redeemed, the coupon application notifies the user. For instance, the coupon application may trigger a notification mechanism on the mobile device, such as an audible, visible, and/or vibrating alert. The alert may indicate the relevant coupon offer as well as the place where it may be redeemed. As another example, the coupon application may visually distinguish between items in a shopping list that are associated with offers that may be redeemed at a nearby place.

According to an embodiment, a shopping list application accesses aisle data indicating, for a particular store, which items are kept on which aisles within the store. Based on this data, the application organizes items within a shopping list in accordance with the aisles at which they may be found. Further based on this data, the application organizes a presentation of coupon offers. For example, if the user selects aisle A3 of a particular store, the shopping list application presents to the user a list of coupon offers that may be applied against items found in aisle A3. The application may organize any set of coupon offers in this fashion. For example, the application may show only coupon offers that have been selected by the user. Or, as another example, the application may show all coupon offers for a particular aisle, even if the user has not previously selected those offers. The user may then select coupon offers of interest to the user. As yet another example, the application may show the user only coupon offers related to items that are both within the aisle and listed in the user's shopping list.

Among other effects, the above-described integrations may provide a user with mechanisms by which the user may locate and access coupon offers of interest while at the same time managing a shopping list, thereby increasing the user's incentives to locate and access coupon offers. Furthermore, the above-described integrations may decrease the effort required of a user to locate interesting coupon offers. In either case, the user is more likely to locate and access coupon offers, in turn increasing the efficiency with which the coupon distributor may distribute coupons to the user.

In other aspects, the invention encompasses a computer apparatus and a computer-readable medium configured to carry out the foregoing steps.

### 2.0. Structural Overview

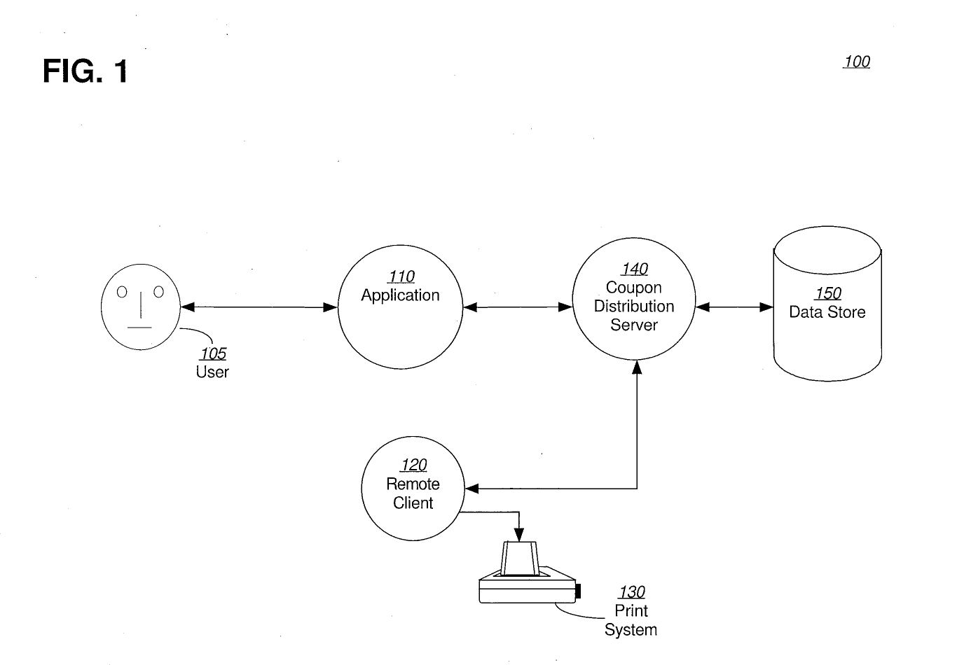

FIG. 1 illustrates an example system 100 in which the techniques described herein may be practiced. System 100 comprises an application 110 that provides a user 105 with integrated shopping list and coupon functionality. Application 110 may utilize and/or be assisted in providing this functionality by a remote client 120, print system 130, server 140, and data store 150.

Application 110 may execute at any of a variety of computing devices operable by user 105, including mobile devices, desktop computing devices, entertainment devices, in-store kiosks, printing devices, and so on. Application 110 utilizes various input and output mechanisms at the executing computing device to provide user 105 with one or more interfaces for creating, viewing, and manipulating a shopping list, as well as one or more interfaces for viewing and selecting coupon offers. In an embodiment, a coupon distributor provides application 110 to user 105 as downloadable software. However, in other embodiments, application 110 may be provided by any other entity, including a retailer, third-party developer, coupon provider, or original equipment manufacturer. Application 110 may further be an embedded application.

Application 110 is communicatively coupled via a network on an at least intermittent basis to a server 140. Server 140 is operated by a coupon distributor for, among other purposes, distributing coupons and assisting users such as user 105 in creating shopping lists. As used herein, a server may refer to one or more applications executing on one or more computers or devices that interact with counterpart client applications executing on other computers or devices. Thus, server 140 may be one or more server applications, executing at one or more computing devices. Server 140 may include, for example, the functionality of a coupon distribution server such as described in U.S. application Ser. No. 12/821,096, entitled “Controlling Coupon Printing To Multiple Types Of Clients,” the contents of which are hereby incorporated by reference for all purposes as if set forth in their entirety.

Application 110 communicates with server 140 to store, search for, retrieve, and/or provide services related to a variety of data from data store 150. Data store 150 comprises one or more databases and/or file repositories, which in turn store data that describes and/or is related to coupon offers, shopping lists, products, and/or retail stores. The coupon distributor may have collected or derived the information in data store 150 from a variety of sources, including coupon providers, manufacturers, retailers, and users.

As an example of the interactions between application 110 and server 140, application 110 may upload a user's shopping list data to server 140 for storage in data store 150. As another example, application 110 may search data store 150 for data associated with items in a shopping list so as to provide user 105 with coupon offers, pricing information, availability data, categorical information, and other data related to the items in the user's shopping list. As another example, application 110 may request that server 140 provide listings of coupon offers described in data store 150, which may or may not be filtered for purposes such as matching items in a shopping cart, matching categories of items in a shopping cart, and matching particular retail stores. As another example, application 110 may request that server 140 authorize application 110 to generate an electronic or printable coupon for a selected coupon offer.

Remote client 120 is also communicatively coupled to server 140. Remote client 120 may provide some or all of the same functionalities as application 110, but instead executes at a different computing device. For example, application 110 may be a mobile application, while remote client 120 may be a desktop application or retail kiosk. Or application 110 may execute at a mobile device operated by user 105, while remote client 120 may execute at a mobile device operated by a different user. In an embodiment, server 140 facilitates the sharing of shopping lists and/or coupon data between application 110 and remote client 120. Thus, user 105 may access the same shopping lists and/or coupon data at either of application 110 or remote client 120, depending on which device is convenient to user 105. For example, application 110 may not be communicatively coupled to a printing device to print a shopping list or coupon. However, if remote client is connected to a printing device such as print system 130, the user 105 may select coupons or create a shopping list at application 110 and then later print the coupons or access the shopping list from remote client 120. User 105 may also share shopping lists and/or coupon data with another user operating remote client 120.

System 100 is but an example of a system in which the techniques described herein may be practiced. Other systems may include additional components, or may lack depicted components. Other systems may also feature different arrangements of components. Several example alternative arrangements are described as follows:

In an embodiment, application 110 maintains its own data store for any or all of the information described above as being stored in data store 150. For example, application 110 may rely on a local repository for product and shopping list data, but on server 140 for coupon data. In an embodiment, application 110 accesses data store 150 directly, foregoing communication with server 140 for some or all of the services described herein as being provided by server 140. In an embodiment, the distribution of work between application 110 and server 140 varies—for example, application 110 may execute logic for managing a shopping list, while server 140 may execute logic for presenting coupon data. In an embodiment, server 140 provides the functionality of application 110 via a web interface. In an embodiment, remote client 120 and application 110 share some or all data directly, without the intervention of server 140. In an embodiment, print system 130 is integrated into the same device that executes application 110 or remote client 120.

In an embodiment, several distinct applications collectively provide the functionality of application 110. For example, a shopping list application may interface with a separate coupon application to provide the functionality described herein as being performed by a single application. The separate applications may or may not execute on the same device. Both applications may be supported on the backend by server 140, or separate shopping list and separate coupon distribution servers may collectively provide the functionality of server 140 on the backend.

### 3.0. Functional Overview

3.1. Shopping List Management

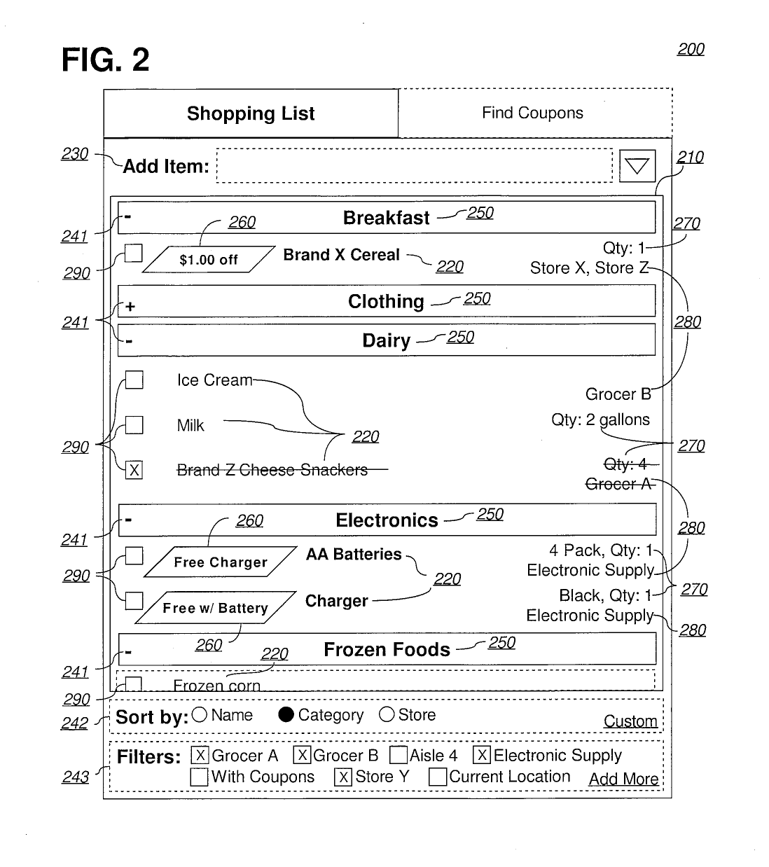

According to an embodiment, an application such as application 110 provides a user with one or more interfaces for viewing and manipulating shopping lists. FIG. 2 depicts an example of such an interface in interface 200. Interface 200 provides a view of an example shopping list 210. Shopping list 210 comprises a set of items 220 that identify products. An item may have a one-to-one correspondence to a product as defined by a UPC code, or may more generically refer to a group of similar products, such as “bread.”

A user may utilize shopping list 220 to, for example, organize a shopping trip or remind himself of products that the user intends to purchase. The user may add items 220 to shopping list 210 via textual input in control 230 and/or selection of items 220 from other various menus and interfaces that may be presented by the application.

Each item of items 220 in shopping list 210 may further be associated with a variety of ancillary shopping data, such as one or more stores from which the user may purchase a product identified by the item, store aisles where the product may be located, one or more categorizations of the item, a quantity or weight to purchase, a size, brand, or style to purchase, an expected price, user notes, and so on. For example, as depicted in FIG. 2, some of items 220 are associated with categorical data 250, coupon data 260, quantity data 270, and store data 280. The ancillary shopping data may be specified by the user and/or determined automatically by the application. For example, the user may specify the size and style of product to purchase, while the application may automatically determine a category for an item. As another example, coupon data 260, describing a coupon that is available for an item 220, may have been generated by the application upon determining that a coupon offer may be applied against a purchase of the product.

Interface 200 further comprises checkboxes 290 associated with items 220 to allow a user to mark an item 220 as purchased. In response to the user marking an item 220 as purchased, the application may remove the item 220 from shopping list 210. In an embodiment, the application may further update a purchase history in response to the user marking an item 220 as purchased. The application (or another application and/or server) may utilize this purchase history for a variety of purposes, such as identifying items 220 that the user may wish to add back to shopping list 210 at a later date, identifying coupon offers of potential interest to the user, and automatically filling in various fields of ancillary shopping data in response to the user adding an item 220 to shopping list 210. In an embodiment, the user may further remove an item 220 from shopping list 210 without marking the item 220 as purchased. In such a case, the user may utilize a delete control (not depicted).

In an embodiment, interface 200 is optimized for use on a mobile device, thus allowing a user to refer to and/or make changes to shopping list 210 as the user is actually shopping. However, in other embodiments, interface 200 may be optimized for use with a variety of computing devices. For example, interface 200 may be presented by a desktop computer or in-store kiosk, and may include controls that allow the user to print a copy of shopping list 210 for reference while shopping. The user may then update the shopping list when the user has completed the shopping trip. As another example, a user may prepare a shopping list through an interface 200 optimized for display at a web browser executing on a desktop computer, and then refer to the shopping list while shopping using an interface 200 provided by a mobile application.

Though referred to as a “list,” shopping list 210 need not necessarily be ordered in any particular fashion. In fact, the application may reorder or restructure shopping list 210 using any suitable data sorting or presentation techniques, such as tree controls 241, sorting control 242, and/or filtering control 243. In an embodiment, interface 200 may include controls for sorting and/or filtering shopping list 210 based on any type of ancillary data. For example, tree control 241 facilitates filtering by category, sorting control 242 facilitates sorting by item name, category, or store, and filtering control 243 facilitates filtering by ancillary data such as store, location, or eligibility for coupon offers.

As stated, interface 200 is but an example of an interface suitable for viewing and manipulating shopping lists. Other interfaces may include additional elements, may omit elements, and/or may be arranged differently. For example, in an embodiment, interface 200 includes a shopping cart, into which items 220 are moved upon being marked via checkbox 290. Items 220 will remain in the shopping cart until the user activates another interface control, such as a “checkout” button, indicating that the items have been purchased.

3.2. Coupon Distribution

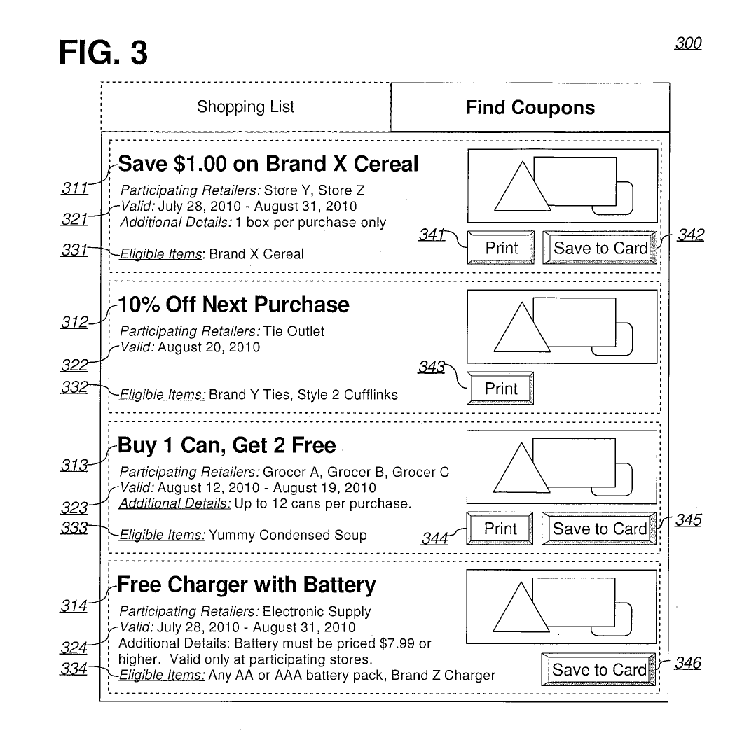

According to an embodiment, an application such as application 110 provides a user with one or more interfaces for viewing and selecting coupon offers. FIG. 3 depicts an example of such an interface in interface 300. Interface 300 provides a user with a list of coupon offers 311-314. Offers 311-314 may be associated with, respectively, terms 321-324 and eligible item sets 331-334. Interface 300 may further includes controls, such as control 340, for sorting and/or filtering coupon offers 311-314 based on a variety of associated data. The associated data, which may or may not include metadata displayed directly within interface 300, may include categorical data, stores at which the coupon offers may be redeemed, coupon prices, and so on.

A user may select one of offers 311-314 using controls 341-346. For example, a user may select control 341 to indicate that the user wishes to print a coupon for offer 311. In response, the application may cause a print system to print a coupon for offer 311. In an embodiment, the application may not be capable of causing a print system to print a coupon. Thus, control 341 might instead trigger an email or other message to the user containing a link and/or instructions for downloading and printing the coupon at a different client. Or, control 341 may save the offer to a coupon list on a server. The user may then print a coupon for the offer by accessing the coupon list from another client.

As another example, a user may select control 342 to generate an electronic coupon for the offer. As depicted, control 342 triggers a mechanism for saving an electronic coupon to a server in association with a card belonging to the user, such as a retailer's customer loyalty card. The user may then redeem the coupon by presenting the customer loyalty card during a transaction with the retailer. However, in an embodiment, control 342 may trigger the creation of any other type of electronic coupon. For instance, control 342 may save an electronic coupon to a data store accessible to a mobile application. During a transaction, the user may utilize the mobile application to present the coupon visually, wirelessly, or through any other suitable mechanism. Various example techniques for generating an electronic coupon are described in, for instance, U.S. application Ser. No. 12/878,231, entitled “Identifier-Based Coupon Redemption,” the contents of which are hereby incorporated by reference for all purposes as if set forth in their entirety.

As stated, interface 300 is but an example of an interface suitable for viewing and manipulating shopping lists. Other interfaces may include additional elements, may omit elements, and/or may be arranged differently. For example, offers 311-314 may or may not be displayed with full terms, conditions, eligible products, and discounts. As another example, interface 300 may facilitate an initial selection of offers to a cart. Interface 300 may then permit the user to select to print or save all of the offers in the user's cart at once.

3.3. Adding Shopping List Items Upon Coupon Selection

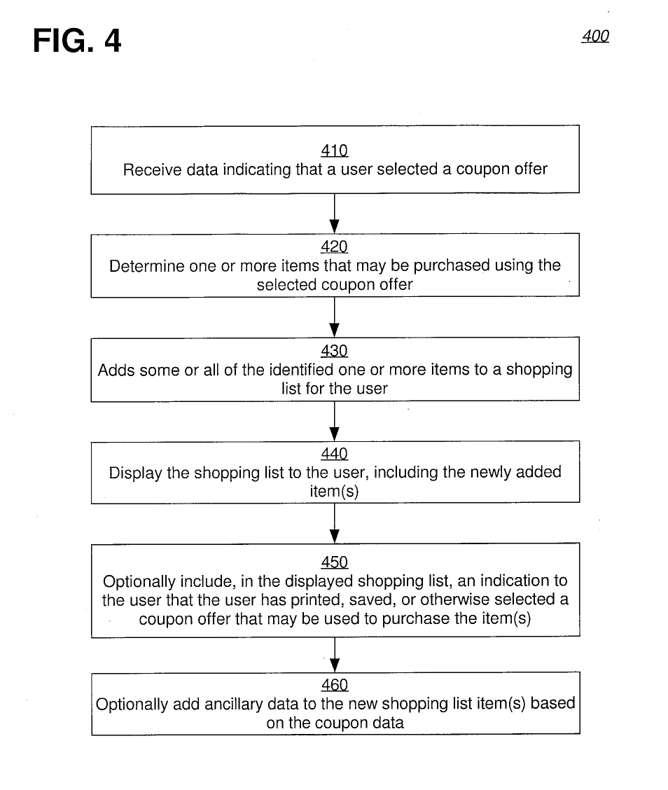

FIG. 4 is a flow chart 400 illustrating an example method for updating a shopping list in response to the selection of a coupon offer.

At block 410, an application receives data indicating that a user selected a coupon offer. For example, block 410 may comprise the application receiving user input through an interface such as interface 300 that selects a coupon offer. As another example, block 410 may comprise the application accessing shared coupon data at a data store indicating that the user selected a coupon offer. For instance, the user may print a coupon at remote client 120, and application 110 may detect the print as a result of communication with server 140 or access to data in data store 150. In an embodiment, a user may have subscribed to periodic electronic coupons from a retailer. The application may perform block 410 in response to the electronic coupon being added to the user's account at the start of a new period.

In an embodiment, block 410 is responsive to a coupon being generated in one form or another, meaning that the illustrated method is only performed if the user is actually authorized to generate a coupon. However, in other embodiments, data indicating user selection of a coupon offer may indicate any selection of a coupon offer for any purpose, including purposes other than generating a coupon. For example, the data received in block 410 may simply indicate that the user selected an “add to shopping list” control associated with the coupon.

At block 420, the application determines one or more items that may be purchased using the selected coupon offer. For example, the application may query a server or data repository for a set of item identifiers that are associated with an identifier for the selected coupon offer.

At block 430, the application adds some or all of the identified one or more items to a shopping list for the user. In an embodiment, if the user has multiple shopping lists, the application may add the item or items to a default shopping list. In an embodiment, the user may instead be presented a menu to select the shopping list to which the item or items are to be added. In an embodiment, if multiple items are eligible for the coupon offer, the application may add all of the items to the shopping list, or may present the user a menu to select a particular item. In an embodiment, the user may be asked to confirm that the user wishes to add the item to the user's shopping list.

At block 440, the application displays the shopping list to the user, including the newly added item(s). For example, the application may display the shopping list in an interface such as interface 200.

At block 450, the application optionally includes, in the displayed shopping list, an indication to the user that the user has printed, saved, or otherwise selected a coupon offer that may be used to purchase the item(s) that were added to the shopping list at block 430. For example, the application may display an indicator such as coupon data 260 of FIG. 2. As another example, the application may display the item differently than other items that are not associated with a selected coupon offer. For instance, the item may be displayed in a different font or with a different background. The item may also or instead be presented at the top of the list to draw attention to the fact that the item is associated with a selected coupon offer.

At block 460, the application optionally adds ancillary data to the new shopping list item(s) based on the coupon data. For example, based on coupon terms specifying retailers that will accept the coupon offer, the application may add store data for an item indicating one or more stores at which the user may purchase the item. As another example, based on coupon terms specifying a quantity of items that must be purchased for coupon eligibility, the application may set the quantity of items to be purchased on the shopping list. As another example, based on coupon terms specifying a size, brand, or flavor of an item that must be purchased for coupon eligibility, the application may set the size, brand, or flavor of the item the shopping list.

FIG. 4 illustrates but one example of a method for updating a shopping list in response to the selection of a coupon offer. Other methods may comprise additional elements, may omit elements, and/or may be arranged in different orders. For example, in an embodiment, an item associated with a coupon offer may already be in a shopping list at the time the coupon offer is selected. In such a case, the item may not necessarily be added again, but blocks 450 and 460 may nonetheless be performed to update the shopping list based on the selected coupon offer.

3.4. Presenting Coupon Offers Upon Adding Shopping List Items

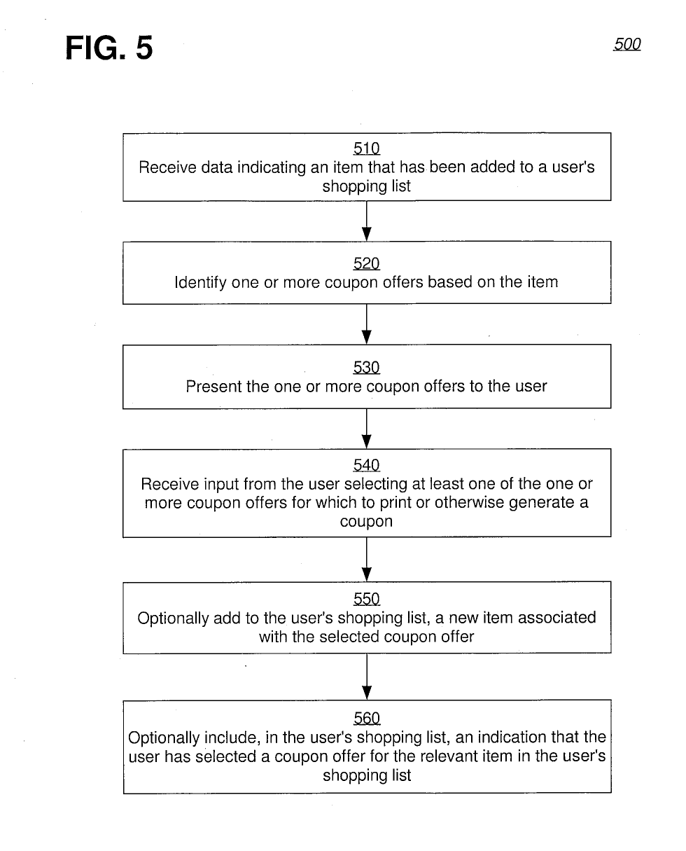

FIG. 5 is a flow chart 500 illustrating an example method of assisting a user in locating coupon offers based on items that have been added to a shopping list.

At block 510, an application receives data indicating an item that has been added to a user's shopping list. The item may have been added to the user's shopping list as a result of any of a variety of actions. For example, the user may have manually typed the name of the item in an interface such as interface 200. The user may have added the item using the same application or a different application. As another example, the item may have been added automatically to the user's shopping list as a recurring shopping item, or in response to an application detecting that the user has a low inventory of the item.

At block 520, the application identifies one or more coupon offers based on the item. In an embodiment, the identified one or more coupon offers are offers that may be applied against the purchase of the item. In an embodiment, the application identifies one or more coupon offers for other items that are related to the item, such as coupon offers for items in a same category as the added item. For instance, if the user adds a particular brand of breakfast cereal to her shopping list, the application may search for coupon offers for other brands of breakfast cereal.

The identification process may comprise a number of comparison and/or matching steps by the application and/or a backend server. For example, the application may perform a search for the item in a product database. If a match is found, an identifier for the product or an associated category is retrieved. The match need not be an exact match of the product title. Rather, any matching technique may be used, including techniques that take into account spelling variants, alternative names, misspellings, item metadata, and so forth. The matching identifier is then used to query a coupon offer database for coupon offers associated with the identifier. Or, the matching identifier may be used to query for other data associated with the item, such as categories and item keywords, which may in turn be used to locate coupon offers.

In an embodiment, the application uses data associated with the item to identify complementary products for which to present coupon offers. For example, the application may utilize the user's purchase history, other user purchase histories, and/or categorical relationship data to determine that milk is often purchased with breakfast cereal. The item thus responds to the addition of milk in the user's shopping list by presenting the user with coupon offers for breakfast cereal. In an embodiment, the application may further examine other items in the user's shopping list for identifying complementary products. For example, the application may determine that a user who has added bread and sandwich meat to her shopping list may be interested in coupon offers for cheese or condiments.

In an embodiment, the coupon distributor may wish to avoid providing coupons for items for which the user has already manifested an intent to purchase. The coupon distributor may, for example, wish to encourage the user to consider coupon offers for alternative or complementary products. In such an embodiment, block 520 further involves ensuring that the identified coupon offers do not include coupon offers that may be applied against the item indicated in block 510. Instead, the application presents to the user coupon offers for other items that are related to the item. For example, the application may filter from the one or more coupon offers any coupon offers that may be applied to the purchase of the item. Or, the application may perform a search for the one or more coupon offers using search criteria that avoids coupon offers that are applicable to the item itself.

In an embodiment, block 520 may also involve filtering any associated coupon offers based on factors such as store preferences, store location, coupon distribution limits, sponsorship arrangements, the user's purchase history, the user's coupon selection history, and so on. In an embodiment, multiple coupon databases may be searched. For example, the application or server may search for matches in any or all of a coupon distributor database, a retailer database, and a manufacturer database. In an embodiment, the databases searched may depend upon factors such as store preferences and/or a category to which the item belongs.

At block 530, the application presents the one or more coupon offers to the user. For example, the application may present the one or more coupon offers in an interface such as interface 300. As another example, the application may simply present the user with a pop-up window alerting the user to the existence of a coupon offer and asking the user if the user wishes to print the offer.

At block 540, the application receives input from the user selecting at least one of the one or more coupon offers for which to print or otherwise generate a coupon.

At block 550, the application optionally adds a new item to the user's shopping list. The application may do so when the coupon offer selected in block 540 may be applied to the purchase of an item not already in the user's shopping list. For example, the selected coupon offer may have been for an item that is complementary to the item indicated in block 510.

In an embodiment, this block may further include removing the item indicated in block 510 from the user's shopping list, if the selected coupon offer is for an item considered to be an alternative to the item indicated in block 510. For example, if the user adds Item Y to his list, the application may detect that there is a coupon offer for an Item Z that is considered to be an alternative to Item Y. Pursuant to block 530, the application may then issue a prompt to the user, such as “There is a $1.00 off coupon for Item Z, would you like to buy it instead?” If the user responds “yes,” pursuant to block 540, the application would then remove Item Y from the list and replace it with Item Z, pursuant to block 550.

At block 560, similar to block 450, the application optionally includes, in the user's shopping list, an indication that the user has selected the coupon offer for the relevant item in the user's shopping list.

FIG. 5 illustrates but one example of a method of assisting a user in locating coupon offers based on items that have been added to a shopping list. Other methods may comprise additional elements, may omit elements, and/or may be arranged in different orders. For example, in an embodiment, blocks 530 and 540 are omitted. Rather, the application may automatically print or otherwise generate a coupon for items added to a shopping list. As another example, in an embodiment, a modified block 560 is performed prior to block 530 and 540. Instead of presenting the user with an indication that the user has selected a coupon offer for the item, block 560 may comprise presenting the user with an indication that one or more coupon offers are available for the item. The user may then select a control associated with the item to trigger blocks 530 and 540.

3.5. Location-Aware Coupon Notification

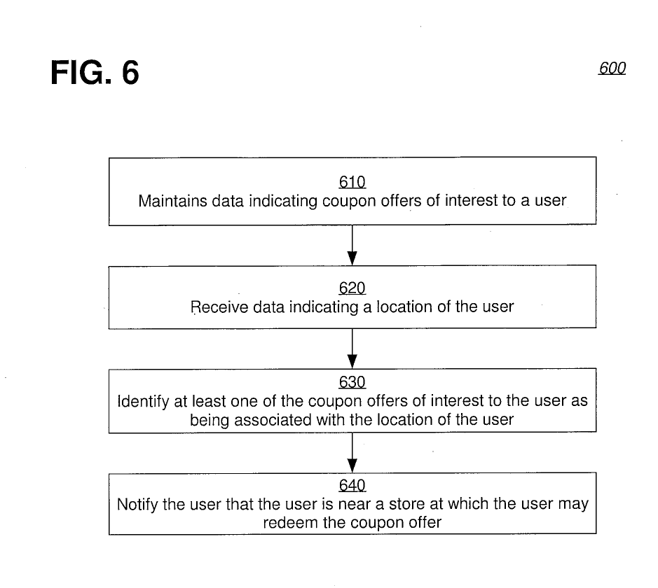

FIG. 6 is a flow chart 600 illustrating an example method of location-aware coupon notification. According to an embodiment, an application such as application 110 implements various aspects of this method at a mobile device with which a user commonly travels, such as a smartphone or personal digital assistant. According to an embodiment, various elements of the method are offloaded to a server capable of tracking location data for a mobile device on which the application is installed.

At block 610, the application maintains data indicating coupon offers of interest to a user. For example, the user may have selected the offers for print or electronic distribution in a coupon interface presented by the application or by another client. However, in an embodiment, the coupon offers may have been determined to be of interest to the user for a variety of other reasons. For example, the user may have previously viewed the coupon offer and/or may have selected the coupon offer as being of interest to the user. As another example, a behavioral analysis component on a server may predict that a coupon offer is of interest to the user based on a purchase history or browsing history.

At block 620, the application receives data indicating a location of the user. The data may be received from a variety of components, including user input, a GPS component, a location application programming interface that identifies an approximate location based on radio signals (such as cellular, wifi, Bluetooth, RFID signals), a module that detects a location based on data from a camera, and so on. In an embodiment, the location is specified with respect to actual coordinates, while in other embodiments the location is specified in terms of a geographic area, such as a zip code, town, store, shopping center, or neighborhood.

At block 630, the application identifies at least one of the coupon offers of interest to the user as being associated with the location of the user. The identification process may comprise a variety of steps, depending on the granularity of the location information available for both the user and the coupon offers. For example, the application may identify, for each coupon offer, one or more stores or chains of stores at which the offer may be redeemed. If the indicated location of the user is specified as a store, the application may simply determine whether the indicated location matches the one or more stores at which the offer may be redeemed. Or, if the location is specified as a coordinate, the application may perform a lookup operation using the user's location to determine stores that are within a threshold radius of the user's GPS coordinates, such as a kilometer or mile. Or, if the location is specified as a geographic location, the application may determine stores that are within the boundaries of that geographic location and, optionally, a threshold radius of the geographic location. As another example, a coupon offer may be associated with a specific coordinate. The user's location may then be translated to the same coordinate system and evaluated to determine if the user is in the vicinity of the coordinate.

In any case, a coupon offer may also be associated with other location information, such as eligible zip codes, that the application may also compare to the user's location before identifying the coupon offer as being associated with the user's location.

At block 640, the application notifies the user that the user is near a store at which the user may redeem the coupon offer. The application may notify the user by performing one or more of: triggering an audible alert or ringtone, sending a message to the user, displaying a visual alert to the user, causing a mobile device to vibrate, displaying the coupon offer differently than other coupon offers in a list of coupon offers, displaying an item associated with the coupon offer differently than other items in a shopping list, listing the coupon offer or an associated item at the top of a shopping list or coupon offer list, and/or displaying the coupon offer or an associated item in a special interface designated for nearby offers or items of interest to the user.

For example, a user may have printed a coupon for a free milkshake at a store X. A coupon application on the user's mobile phone may be aware of the printed coupon, possibly because of interaction between the application and a coupon distribution server, or because the user entered the location information into the mobile phone by hand. When the application detects that the user is within a few blocks of store X, the application may play a special ringtone alerting the user to the fact that she had printed a coupon for store X.

As another example, a user may have saved certain coupons to a club card associated with store Y. A shopping list application on the user's digital book reader may be aware of the saved coupons either because, for instance, the user saved the coupons using the application and/or the application communicated with a server that maintains such information. When the user opens the shopping list application to view the shopping list, the application may detect that the user is in store Y. As a result, the application may sort the shopping list so that items for which the user has saved coupons eligible for use at store Y are ranked higher than other items. Moreover, the application may display the items with a distinctive colored background and a coupon indicator.

FIG. 6 illustrates but one example of a method of location-aware coupon notification. Other methods may comprise additional elements, may omit elements, and/or may be arranged in different orders. For example, in an embodiment, an application detects locations that are associated with items, in addition to or instead of coupon offers. Thus, a user may be alerted to the fact that the user is near a location where the user may purchase an item on the user's shopping list, regardless of whether that item is associated with a coupon offer.

In an embodiment, the above described behavior is configurable on an item, category, or store level. Thus, for example, the user may configure an application to alert the user when the user is near a store where the user may redeem a particularly valuable coupon, but to avoid alerts for a store at which the user is commonly near.

3.6. Aisle-Based Coupon Presentation

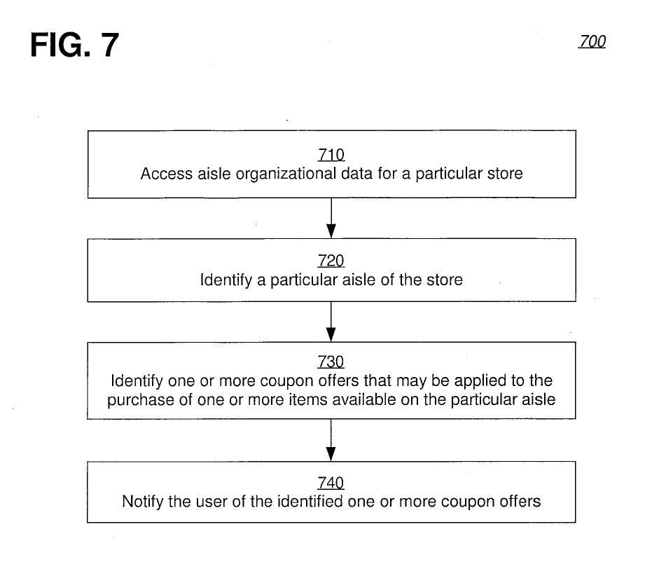

FIG. 7 is a flow chart 700 illustrating a method of aisle-based coupon presentation. The method may be performed in part, for example, by an application executing on a user's mobile phone while the user is shopping in a store. Or, as another example, the application may execute at a user's desktop computer to print shopping lists organized by aisles.

At block 710, the application accesses aisle organizational data for a particular store. The aisle organization data comprises a plurality of items, each associated with an aisle in the particular store at which products corresponding to the item may be found. For example, an “eggs” item may be associated with aisle A, while a “batteries” item may be associated with aisle D. The aisle organization data may or may not include aisle information for every item sold in the store. The aisle information may have been provided by, for example, the user, other users, the store, the coupon distributor, coupon providers, and so on. In an embodiment, the aisle information is crowd-sourced, in that as one user updates aisle information for a particular store, that information is made available for other users. The aisle organization data is maintained locally and/or at a server.

At block 720, the application identifies a particular aisle of the store. The particular aisle may be identified by user input and/or by a sensing mechanism available to the application.

At block 730, the application identifies one or more coupon offers that may be applied to the purchase of one or more items available on the particular aisle. In an embodiment, the application specifically identifies coupon offers for which the user has already selected to print or otherwise generate a coupon. In an embodiment, the application specifically identifies coupon offers that may be applied to the purchase of one or more items in the user's shopping list. In an embodiment, the application combines both of the above criteria. In an embodiment, the application identifies all coupon offers that may be applied to the purchase of one or more items available on the particular aisle. In an embodiment, the application may specifically avoid identifying coupon offers that have been selected by the user or that may only be applied to the purchase of items already in the user's shopping list, so as to provide the user with advertising for products that the user may not have already considered purchasing.

At block 740, the application notifies the user of the identified one or more coupon offers. The application may present the one or more coupon offers in a variety of manners, including as indicators in a shopping list that has been filtered for the aisle, as a coupon offer list filtered for the aisle, as a pop-up notification, and so on.

FIG. 7 illustrates but one example of a method of aisle-based coupon presentation. Other methods may comprise additional elements, may omit elements, and/or may be arranged in different orders. For example, in an embodiment, the aisle organization data comprises a plurality of coupon offers associated with specific offers, thus allowing the application to forego item-based coupon offer lookup operations. As another example, a user may be informed of items in the user's shopping list that are found on a particular aisle, regardless of whether those items are associated with coupon offers. For example, the application may filter the user's shopping list for a particular aisle. The list may then be sorted by coupon offer availability.

In an embodiment, block 720 is omitted, and blocks 730-740 are repeated for each aisle in the store. The user may then be presented with an aisle-by-aisle shopping list. The aisle-by-aisle shopping list may include coupon indicators for items that are eligible for coupon offers, and/or may be filtered to include only coupon-eligible items.

3.7. Coupon Eligibility Validation

In an embodiment, certain coupon offers may require a user to purchase more than one product. For example, a coupon offer may specify that if the user buys two packages of a certain product, the user is entitled to another package of that product free. Or, the coupon may specify that to receive a discount on a purchase, the user must purchase product A and product B. To assist the user in meeting such eligibility requirements, an application may provide features such as described below.

In an embodiment, when a user selects a coupon offer that requires the user to buy more than one item, the application adds to the user's shopping list the correct quantity of items that must be purchased in order to satisfy the coupon offer's eligibility requirements.

In an embodiment, when selecting coupon-eligible items to add to a shopping list, pursuant to block 430 of FIG. 4, if the user does not select a combination of items that meet the coupon offer's eligibility requirements, the application reminds the user of the eligibility requirements and provides the user with options to meet the coupon offer's eligibility. In an embodiment, the application may enforce selection of an eligible combination of items. However, in an embodiment, the user may override the application's suggestions.

In an embodiment, in response to the selection of a coupon offer for an item in the user's shopping list, pursuant to block 540 of FIG. 5, the application may at block 550 add or prompt the user to add other items to the user's shopping list based on the coupon offer's eligibility requirements, in similar manner to block 430 of FIG. 4.

In an embodiment, when a user marks an item as being in the user's shopping cart, the application may highlight or otherwise remind the user of other items that must be purchased in order to satisfy the requirements of a coupon offer that the user has selected. In an embodiment, the application may additionally or instead remind the user of the items missing for coupon eligibility when the user indicates to the application that the user is ready to make a purchase, such as when the user activates a “checkout” or “shopping list verification” control.

In an embodiment, when a user marks an item as being in the user's shopping cart, the application may also or instead inform the user of non-selected coupon offers for which the user may be eligible if the user purchases additional items. The user may then be given the option to select the coupon offer and add the additional items to the user's shopping list.

3.8. Sharing Data

In an embodiment, multiple users may use an application such as application 110 on their respective devices to shop collaboratively. In an embodiment, a first user may instruct the application to send and/or share a shopping list with a second user. Both users may add and/or remove items from the shopping list. The users may further share coupon data. Thus, for example, if the first user has printed or otherwise generated a coupon, the application is able to provide some or all of the above-described integrations for the second user with respect to the coupon printed by the first user.

In an embodiment, each user may execute the application on their respective mobile devices. The users may thus update a shared shopping list in real-time while shopping. When a first user marks an item as being in the first user's shopping cart, the second user sees that the item is in the first user's shopping cart in near real-time. The application may depict each user's shopping cart separately, or depict them as combined. The application may provide coupon-eligibility verification as described above to one or both users based on the combined contents of the users' shopping carts.

In an embodiment, purchase histories and coupon histories may also be shared between users. For example, if a first user routinely adds a particular item to a shopping list, the second user may be presented with a coupon offer for the particular item the next time the second user accesses a new coupon interface.

The above-described techniques may, of course, be extended to collaborative shopping amongst any number of users.

### 4.0. Implementation Mechanism—Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

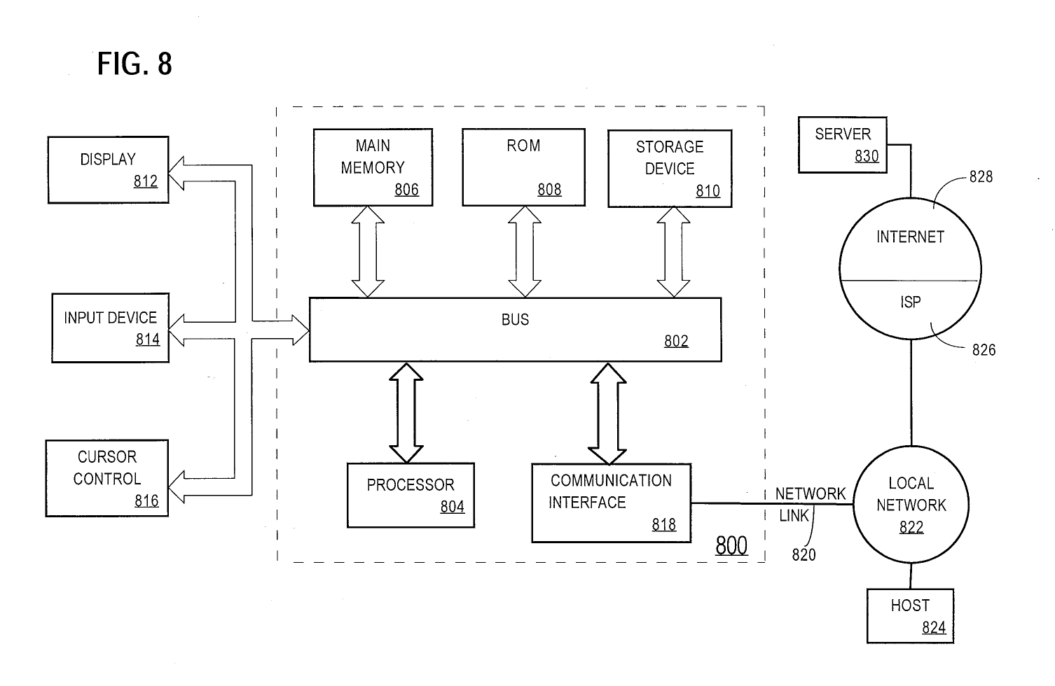

For example, FIG. 8 is a block diagram that illustrates a computer system 800. Computer system 800 includes a bus 802 or other communication mechanism for communicating information, and a hardware processor 804 coupled with bus 802 for processing information. Hardware processor 804 may be, for example, a general purpose microprocessor.

Computer system 800 also includes a main memory 806, such as a random access memory (RAM) or other dynamic storage device, coupled to bus 802 for storing information and instructions to be executed by processor 804. Main memory 806 also may be used for storing temporary variables or other intermediate information during execution of instructions to be executed by processor 804. Such instructions, when stored in non-transitory storage media accessible to processor 804, render computer system 800 into a special-purpose machine that is customized to perform the operations specified in the instructions.

Computer system 800 further includes a read only memory (ROM) 808 or other static storage device coupled to bus 802 for storing static information and instructions for processor 804. A storage device 810, such as a magnetic disk or optical disk, is provided and coupled to bus 802 for storing information and instructions.

Computer system 800 may be coupled via bus 802 to a display 812, such as a cathode ray tube (CRT), for displaying information to a computer user. An input device 814, including alphanumeric and other keys, is coupled to bus 802 for communicating information and command selections to processor 804. Another type of user input device is cursor control 816, such as a mouse, a trackball, or cursor direction keys for communicating direction information and command selections to processor 804 and for controlling cursor movement on display 812. This input device typically has two degrees of freedom in two axes, a first axis (e.g., x) and a second axis (e.g., y), that allows the device to specify positions in a plane.

Computer system 800 may implement the techniques described herein using customized hard-wired logic, one or more ASICs or FPGAs, firmware and/or program logic which in combination with the computer system causes or programs computer system 800 to be a special-purpose machine. According to one embodiment, the techniques herein are performed by computer system 800 in response to processor 804 executing one or more sequences of one or more instructions contained in main memory 806. Such instructions may be read into main memory 806 from another storage medium, such as storage device 810. Execution of the sequences of instructions contained in main memory 806 causes processor 804 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 810. Volatile media includes dynamic memory, such as main memory 806. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 802. Transmission media can also take the form of acoustic or light waves, such as those generated during radio-wave and infra-red data communications.

Various forms of media may be involved in carrying one or more sequences of one or more instructions to processor 804 for execution. For example, the instructions may initially be carried on a magnetic disk or solid state drive of a remote computer. The remote computer can load the instructions into its dynamic memory and send the instructions over a telephone line using a modem. A modem local to computer system 800 can receive the data on the telephone line and use an infra-red transmitter to convert the data to an infra-red signal. An infra-red detector can receive the data carried in the infra-red signal and appropriate circuitry can place the data on bus 802. Bus 802 carries the data to main memory 806, from which processor 804 retrieves and executes the instructions. The instructions received by main memory 806 may optionally be stored on storage device 810 either before or after execution by processor 804.

Computer system 800 also includes a communication interface 818 coupled to bus 802. Communication interface 818 provides a two-way data communication coupling to a network link 820 that is connected to a local network 822. For example, communication interface 818 may be an integrated services digital network (ISDN) card, cable modem, satellite modem, or a modem to provide a data communication connection to a corresponding type of telephone line. As another example, communication interface 818 may be a local area network (LAN) card to provide a data communication connection to a compatible LAN. Wireless links may also be implemented. In any such implementation, communication interface 818 sends and receives electrical, electromagnetic or optical signals that carry digital data streams representing various types of information.

Network link 820 typically provides data communication through one or more networks to other data devices. For example, network link 820 may provide a connection through local network 822 to a host computer 824 or to data equipment operated by an Internet Service Provider (ISP) 826. ISP 826 in turn provides data communication services through the world wide packet data communication network now commonly referred to as the “Internet” 828. Local network 822 and Internet 828 both use electrical, electromagnetic or optical signals that carry digital data streams. The signals through the various networks and the signals on network link 820 and through communication interface 818, which carry the digital data to and from computer system 800, are example forms of transmission media.

Computer system 800 can send messages and receive data, including program code, through the network(s), network link 820 and communication interface 818. In the Internet example, a server 830 might transmit a requested code for an application program through Internet 828, ISP 826, local network 822 and communication interface 818.

The received code may be executed by processor 804 as it is received, and/or stored in storage device 810, or other non-volatile storage for later execution.

### 5.0. Extensions and Alternatives

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method comprising:
receiving data indicating a selection of a coupon offer by a user;
identifying an item associated with the selected coupon offer;
in response to receiving the data indicating the selection of the coupon offer by the user, adding the item to a shopping list for the user;
displaying the shopping list to the user, including the item;
wherein the method is performed by one or more computing devices.

2. The method of claim 1, wherein the data indicating the selection of the coupon offer by the user further indicates that the user selected to receive a print or electronic coupon for the coupon offer.

3. The method of claim 1, wherein the shopping list includes one or more other items not associated with the selected coupon offer.

4. The method of claim 3, further comprising displaying in the shopping list, with the item, an indication that the user selected the coupon offer.

5. The method of claim 1, further comprising:
identifying a plurality of items required for eligibility for the selected coupon offer;
determining that at least one or the plurality of items is not in the user's shopping list;
in response to the determining, performing at least one of:
notifying the user that the at least one item is not in the user's shopping list; or
automatically adding the at least one item to the user's shopping list.

6. The method of claim 1, wherein adding the item to a shopping list for the user is performed further in response to the user selecting the item from a list of one or more items eligible for the selected coupon offer.

7. A method comprising:
receiving data indicating an item that has been added to a shopping list;
identifying one or more coupon offers based on data associated with the item;
in response to receiving the data indicating the item that has been added to the shopping list, presenting the one or more coupon offers to the user;
responsive to presenting the one or more coupon offers to the user, receiving selection, from the user, of a particular coupon offer of the one or more coupon offers;
in response to the user selecting the particular coupon offer, generating a print or electronic coupon for the particular coupon offer;
wherein the method is performed by one or more computing devices.

8. The method of claim 7, further comprising:
displaying in the shopping list, with the item, an indicator that the user selected the particular coupon offer.

9. The method of claim 7, wherein identifying the one or more coupon offers based on the data associated with the item comprises identifying at least one coupon offer that may be applied to the purchase of the item.

10. The method of claim 7, wherein identifying the one or more coupon offers based on the data associated with the item comprises:
identifying one or more other items associated with the item;
identifying at least one coupon offer that may be applied to the purchase of the one or more other items.

11. The method of claim 10, wherein identifying the one or more coupon offers based on the data associated with the item further comprises ensuring that the one or more coupon offers does not include any coupon offers that may be applied to the purchase of the item.

12. The method of claim 7, wherein identifying the one or more coupon offers based on the data associated with the item comprises:
identifying a plurality of coupon offers that may be applied to the purchase of the item;
selecting, from the plurality of coupon offers, only those coupon offers that require the purchase of one or more items in addition to the item.

13. The method of claim 7, further comprising:
identifying one or more other items that must be purchased with the item for the item to be eligible for the particular coupon offer;
adding the one or more other items to the shopping list.

14. The method of claim 7, wherein the data indicating the item that has been added to the shopping list further indicates that the user has marked the item as being in the user's shopping cart.

15. A method comprising:
maintaining data indicating a set of coupon offers selected by a user;
receiving data indicating a location associated with the user;
identifying one or more coupon offers in the set of coupon offers that are associated with the location;
in response to the data indicating the location, notifying the user of the identified one or more coupon offers.

16. The method of claim 15, wherein the data indicating the set of coupon offers selected by the user further indicates that the user selected to receive a print or electronic coupon for each of the coupon offers in the set of coupon offers.

17. The method of claim 15, wherein notifying the user of the identified one or more coupon offers comprises:
displaying a shopping list;
displaying, in the shopping list, one or more indications of the identified one or more coupon offers in association with one or more more items to which the identified one or more coupon offers may be applied.

18. The method of claim 15, wherein notifying the user of the identified one or more coupon offers comprises displaying a filtered shopping list comprising only items to which the identified one or more coupon offers may be applied.

19. A method comprising:
maintaining data indicating aisle locations of each item within a set of items;
generating a presentation of coupon offers for one or more items in the set of items, wherein the presentation is organized based at least upon the data indicating aisle locations.

20. The method of claim 19, wherein the coupon offers are coupon offers for which a user previously requested a print or electronic coupon.

21. The method of claim 19, wherein the presentation of coupon offers is integrated into a display of items that have been added to a user's shopping list.

22. One or more computer readable storage media storing instructions that, when executed by a mobile device, cause the mobile device to perform:
displaying a shopping list of a plurality of items entered by a user;
displaying a plurality of coupon offers to a user;
responsive to displaying the plurality of coupon offers to the user, receiving first input from the user selecting a coupon offer from the plurality of coupon offers;
identifying an item associated with the selected coupon offer;
in response the first input:
responsive to determining that the item is not already in the shopping list, adding the item to the shopping list; and
causing a print or electronic coupon to be generated for selected coupon offer;
displaying the shopping list to the user, including the item and an associated coupon indicator, wherein the coupon indicator indicates that the print or electronic coupon has been generated for the selected coupon offer, wherein at least one of the plurality of items is not associated with any coupon indicator;
receiving second input from the user indicating that the user has purchased the item;
in response to the second input, removing the item and the coupon indicator from the shopping list.

23. The one or more computer readable storage media of claim 22, wherein the instructions, when executed by the mobile device, further cause the mobile device to perform:
determining the plurality of coupon offers to display to the user based on data identifying items that are related to a set of one or more items of the plurality of items in the shopping list;
wherein the plurality of coupon offers are selected in such a manner as to ensure that each coupon offer in the plurality of coupon offers is associated with at least one item that is not in the set of one or more items.
